(19) United States
(12) Patent Application Publication
(10) Pub. No.: US 2023/0288715 A1
(43) Pub. Date: Sep. 14, 2023

(54) BEAM SPLITTING DEVICE

(71) Applicant: LEICA MICROSYSTEMS CMS GMBH, Wetzlar (DE)

(72) Inventor: Hilmar GUGEL, Wetzlar (DE)

(21) Appl. No.: 18/019,831

(22) PCT Filed: Aug. 11, 2020
(86) PCT No.: PCT/EP2020/072533

§ 371 Date: Feb. 6, 2023

(51) Int. Cl. G02B 27/10; G02B 21/00

(52) U.S. Cl. CPC G02B 27/1006; G02B 21/0032; G02B 27/283

(57) ABSTRACT

A beam splitting device for separating illumination light and detection light in an optical apparatus, including a light supply configured to supply the illumination light including first illumination light having wavelengths within a first wavelength range and second illumination light having wavelengths within a second wavelength range. The beam splitting device also includes an acousto-optical component tunable to diffract at least one spectral component of the first illumination light having a selected wavelength within the first wavelength range to generate at least one illumination light beam of a predetermined diffraction order while transmitting the second illumination light within the second wavelength range without diffraction. The beam splitting device also includes a light coupler configured to couple the first and the second illumination lights into the acousto-optical component. The light supply is configured to supply the first and second illumination lights collinearly to the light coupler.

### CROSS REFERENCE TO RELATED APPLICATIONS

This application is a U.S. National Phase application under 35 U.S.C. § 371 of International Application No. PCT/EP2020/072533, filed on Aug. 11, 2020. The International Application was published in English on Feb. 17, 2022 as WO 2022/033663 A1 under PCT Article 21(2).

### FIELD

The present invention relates to a beam splitting device for separating illumination light and detection light in an optical apparatus. The present invention also relates to an optical apparatus comprising a beam splitting device.

### BACKGROUND

In the field of microscopy, it is often necessary to separate illumination light and detection light which have different wavelengths and propagate along a common optical path. For instance, in a fluorescence application, it may be desirable to filter specific color bands for both excitation and fluorescence emission. For this purpose, beam splitting devices based on dichroic optical elements, colored filters and mirrors may be used. Although a great variety of such optical elements is available, these elements have their limitations in terms of flexibility in wavelength selection.

Recently, acousto-optical components have been used as beam splitters as disclosed in EP 1 055 144 B1, EP 1 281 997 B1, and EP 1 421 427 B1. Such an acousto-optical component may be formed by a material like glass or quartz or a crystalline material. For example, the material might consist of tellurium dioxide, TeO2. The acousto-optical component comprises a piezoelectric transducer which can be electrically controlled to create sound waves in the material which can be thought of as moving periodic planes of expansion and compression that change the index of refraction. Light entering the crystal is diffracted due to the resulting periodic index modulation, and an interference occurs similar to Bragg diffraction. Thus, the acousto-optical component can be freely tuned to diffract one or more components of the light entering the crystal, wherein the diffracted light component emerges from the crystal in a direction which is different from the propagation direction of the undiffracted light. Thus, a spatial separation of light can be conveniently achieved.

However, a typical acousto-optical component is limited in its spectral width, i.e. in terms of the range of light wavelengths which can be processed by the acousto-optical component. Currently, the spectral width of an acousto-optical component typically covers a range which is less than an octave, e.g. from approximately 440 nm to 800 nm. Provided that no light outside this standard range is needed, the entire light can be supplied to the acousto-optical component via a single port. However, a wavelength extension beyond the standard range is technically very difficult to realize. Thus, in case that additional light with wavelengths outside the standard range is needed, this additional light must be coupled into the system via a second port by-passing the acousto-optical component. Using two or more ports for supplying the light in its entirety to the system has the disadvantage that the different light components have to be spatially adjusted to each other in terms of their light propagation directions.

### SUMMARY

In an embodiment, the present disclosure provides a beam splitting device for separating illumination light and detection light in an optical apparatus, comprising a light supply configured to supply the illumination light including first illumination light having wavelengths within a first wavelength range and second illumination light having wavelengths within a second wavelength range, the first and second wavelength ranges being separated from each other. The beam splitting device also comprises an acousto-optical component tunable to diffract at least one spectral component of the first illumination light having a selected wavelength within the first wavelength range to generate at least one illumination light beam of a predetermined diffraction order while transmitting the second illumination light within the second wavelength range without diffraction. The beam splitting device also comprises a light coupler configured to couple the first illumination light and the second illumination light from the light supply into the acousto-optical component. The light supply is configured to supply the first illumination light and the second illumination light collinearly to the light coupler, and the light coupler is configured to spatially separate the first illumination light and the second illumination light for directing the spatially separated first and second illumination lights along different light propagation directions into the acousto-optical component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic diagram of a laser scanning microscope including a beam splitting device;

FIG. 2 illustrates a schematic diagram showing a laser scanning microscope including a beam splitting device according to an embodiment;

FIG. 3 illustrates a schematic diagram showing the laser scanning microscope of FIG. 2 based on a different illustration of the optical paths provided by the beam splitting device;

FIG. 4 illustrates a schematic diagram showing the laser scanning microscope including a beam splitting device according to an embodiment; and

FIG. 5 illustrates a schematic diagram showing the laser scanning microscope including a beam splitting device according to an embodiment;

### DETAILED DESCRIPTION

In an embodiment, the present invention provides a beam splitting device which is capable of separating illumination light and detection light in an optical apparatus in a reliable and compact manner.

A beam splitting device for separating illumination light and detection light in an optical apparatus comprises a light supply unit configured to supply the illumination light including first illumination light having wavelengths within a first wavelength range and second illumination light having wavelengths within a second wavelength range, the first and second wavelength ranges being separated from each other. The beam splitting device further comprises an acousto-optical component tunable to diffract at least one spectral component of the first illumination light having a selected wavelength within the first wavelength range to generate at least one illumination light beam of a predetermined diffraction order while transmitting the second illumination light within the second wavelength range without diffraction. The beam splitting device further comprises a light coupling unit configured to couple the first illumination light and the second illumination light from the light supply unit into the acousto-optical component. The light supply unit is configured to supply the first illumination light and the second illumination light collinearly to the light coupling unit. The light coupling unit is configured to spatially separate the first illumination light and the second illumination light for directing the spatially separated first and second illumination lights along different light propagation directions into the acousto-optical component.

The beam splitting device allows to introduce the entire light, which comprises the first illumination light and the second illumination lights, via one single port into an optical illumination path leading to the sample to be imaged. For this purpose, the entire illumination light is guided through the acousto-optical component, and the acousto-optical component is controlled to diffract only the first illumination light whereas the second illumination light remains unaffected by diffraction. The light coupling unit serves to couple the first and second illumination lights along different propagation paths into the acousto-optical component, these propagation paths being selected in such a way that the first and second illumination lights emerging from the acousto-optical component are combined as desired to illuminate the sample jointly.

Thus, in contrast to conventional approaches which use spatially separated ports as for example several optical fibers for introducing the different spectral components into the illumination path, the beam splitting device proposed herein enables the first and second illumination light to be guided through the same optical components. As a result, adverse effects due to drift caused by thermal expansion or due to misalignment can be reliably avoided. In particular, a lateral shift of the focus of the illumination light originating from one port relative to the focus of the illumination light originating from another port can be prevented from occurring. Accordingly, any instabilities between the illumination foci and color-dependent offsets of the foci can be avoided

In addition, compared to conventional approaches, providing only one port for coupling the illumination light into the system requires a smaller number of optical components, mountings and adjustment elements as optical fibers, lenses, mirrors etc. up to the point in the illumination path where the illumination light is combined. Thus, the costs for implementing the proposed configuration are relatively low.

The spatial separation of the first and second illuminations lights caused by the light coupling unit is not to be understood in a strict sense that the first and second wavelength ranges must be completely separated from each other, i.e. only light of the first wavelength range propagates along a first direction into the acousto-optical component and only light of the second wavelength range propagates along a second direction into the acousto-optical component. Although such a complete light separation may be desirable, from a practical point of view, it may be sufficient that the light coupling unit is configured to spatially separate the first illumination light and the second illumination light at least to a major extent from each other. Thus, in case that the light coupling unit uses e.g. a dichroic element which reflects and transmits different spectral components to provide light separation, it may not be possible to achieve a complete separation, in particular if the spectral components which are to be separated from each other are spectrally close together. For instance, a separation to a major extent may be realized in case that the light coupling unit enables the first and second illumination lights to be separated to an extent greater than 50%, preferably greater than 70%, and even better greater than 90%. In such a case, less than 50%, 30%, or 10% of the intensity of the respective illumination light is separated into the false channel, i.e. propagates into the acousto-optical component along a direction which is actually intended for the other illumination light. Just for simplicity, complete separation is assumed in the following description bearing in mind that the first and second illumination lights may be separated only to a major or predominant extent.

The light supply unit is a component which is used to introduce the illumination light into an optical illumination path of the optical apparatus. For this purpose, the supply unit may comprise one or more optical fibers and/or one or more light sources, in particular laser sources which emit the illumination light into the fiber(s). The laser sources may be combined to a module which is included in the supply unit. Further, a so-called white light laser (supercontinuum laser) source may be included in the supply unit which emits laser light with a continuous spectrum. Apart from the components mentioned above, the supply unit may comprise further elements of other types as for example one or more optical filters, a scanner, etc.

Without being limited thereto, the beam splitting device can be advantageously used in a microscope, in particular a laser scanning microscope where the illumination light is applied to a sample to excite fluorescent light that is detected for imaging the sample.

In a preferred embodiment, the light supply unit comprises a single optical fiber which is configured to emit the first illumination light and the second illumination light collinearly towards the light coupling unit. The optical fiber may be a single mode fiber, and a light output end thereof can be effectively used as single point light source.

Preferably, the acousto-optical component is configured to transmit the detection light without diffraction. In this case, the acousto-optical component may be used with regard to the second illumination light and the detection light as a passive, i.e. not actively controlled element which affects the light only by refraction rather than by diffraction.

The light coupling unit may comprise an optical element which is configured to reflect the first and second illumination lights along the different propagation directions into the acousto-optical component. For example, the optical element may be formed by prism having suitable geometry to allow the different directions of incidence of the first and second illumination lights on the acousto-optical component.

In a specific embodiment, the light coupling unit may comprise a front surface facing towards the light supply unit and a back surface facing away from the supply unit. The front surface may comprise a first front surface portion with a dichroic layer configured to reflect one of the first and second lights towards the acousto-optical component and to transmit the other of the first and second lights by refraction towards the back surface. The back surface may comprise a first back surface portion configured to reflect the other of the first and second lights back to the front surface. The front surface may comprise a second front surface portion spatially separated from the first front surface portion and configured to transmit the other of the first and second lights reflected back from the first back surface portion by refraction towards the acousto-optical component. The first back surface portion may be non-parallel to at least one of the first and second front surface portions.

By using non-parallel surface portions of a front surface and a back surface of the light coupling unit, respectively, the design of the light coupling unit can be easily and precisely tailored to the different directions of incidence of the first and second illumination lights on the acousto-optical component. Differences in the two illumination directions are primarily given by the manufacturing accuracy of the light coupling units.

It should be noted that the dichroic layer need not be limited to the first front surface portion. Rather, the dichroic layer may cover the entire front surface of the light coupling unit to simplify the production.

Preferably, the first back surface portion comprises a reflective coating, for example a metallic coating or a dielectric coating, configured to reflect the other of the first and second lights back to the second front surface portion. A dielectric or metallic coating is suitable to reflect the respective light back to the front surface of the light coupling unit, and at the same time it can be used to influence the polarization state of the reflected light as desired.

The front surface including the first and second front surface portions may be formed by a single planar surface, wherein the first back surface portion is non-parallel to said planar front surface. In this case, a tilt angle of the back surface portion relative to the planar front surface can be precisely selected in accordance with the desired difference between the directions along which the first and second illumination lights propagate towards the acousto-optical component.

According to an embodiment, the back surface including the first back surface portion is formed by a single planar surface, wherein one of the first and second front surface portions is non-parallel to said planar back surface while the other of the first and second front surface portions is parallel to said planar back surface. Also this allows to adjust precisely the intended difference between the directions along which the first and second illumination lights propagate towards the acousto-optical component. Again, differences in the two illumination directions are primarily given by the manufacturing accuracy of the light coupling units.

The back surface may comprise a second back surface portion which is parallel to one of the first and second front surface portions.

According to a preferred embodiment, the optical element is configured to transmit the detection light through those surface portions of the front and back surfaces which are parallel to each other. Since the detection light passes through parallel surface portions of the light coupling unit, only a parallel displacement of the detection light is caused by the light coupling unit. As a result, an optical detection path can be configured easily.

Preferably, the light coupling unit and the acousto-optical component are adapted to each other such that the at least one diffracted illumination light beam of the first illumination light and the second illumination light transmitted without diffraction emerge from the acousto-optical component collinearly or at least in parallel. In particular when the emerging light components are combined collinearly, any focus shifts of the illumination light can be avoided in the sample.

In a preferred embodiment, the beam splitting device comprises optical means configured to alter a polarization state of at least one of the first and second illumination lights such that the at least one diffracted illumination beam of the first illumination light and the second illumination light emerges from the acousto-optical component with equal polarization states. The afore-mentioned means altering the polarization state may comprise a reflective coating which is e.g. applied to the back surface of the light coupling unit. Alternatively, a waveplate may be used which rotates the polarization direction of one of the first and second illumination lights by a certain amount, e.g. 90° relative to the other illumination light. The waveplate may be located upstream of a position where the first and second illuminations lights enter the common optical fiber emitting the light towards the light coupling unit.

The light coupling unit and the acousto-optical component may be adapted to each other to compensate for dispersion. The illumination light which propagates between the front and back surfaces of the light coupling unit undergoes dispersion. As a result, a wavelength-dependent angular splitting of the illumination light may occur when the illumination light emerges from the light coupling unit towards the acousto-optical component. On the other hand, also the acousto-optical component may cause dispersion and thus angular splitting of the light. This can be considered when selecting a suitable material of the light coupling unit in order to compensate for adverse dispersion effects.

The beam splitting device may comprise an additional acousto-optical component for transmitting the detection light towards a detector, wherein the additional acousto-optical component is configured to compensate for a prismatic effect caused by the acousto-optical component. The additional acousto-optical component may be structurally identical with the other acousto-optical component and opposedly oriented thereto. The additional acousto-optical component may form a passive element in terms of diffraction. However, the additional acousto-optical component can also be used as a second active element to further or additionally suppress certain wavelengths or polarization components.

According to an aspect, an optical apparatus is provided which comprises a beam splitting device as disclosed herein. The optical apparatus may be a microscope, in particular a laser scanning microscope.

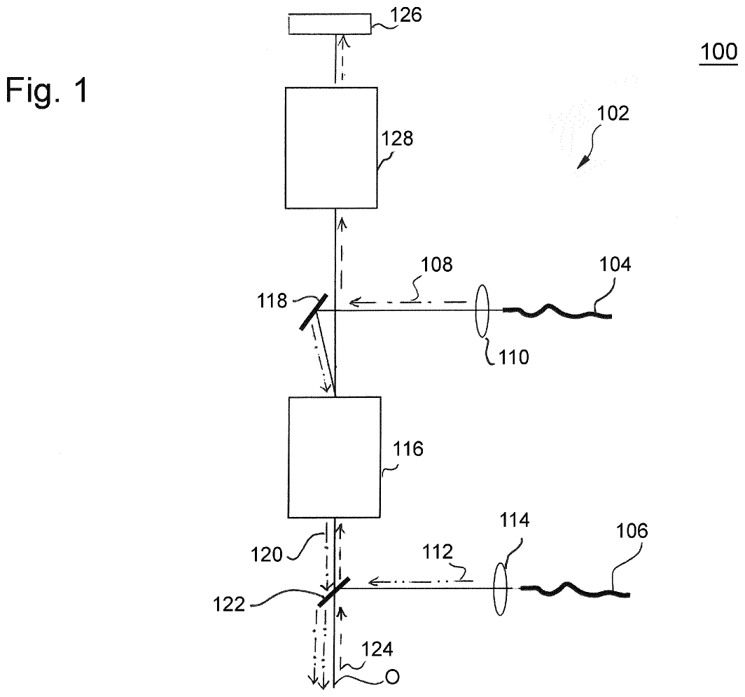

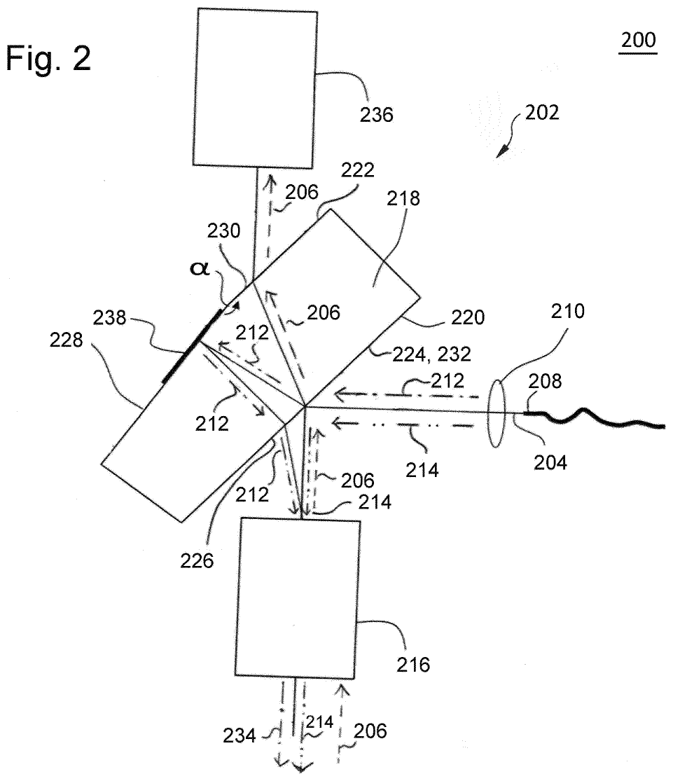

At first, a comparative example is explained with reference to FIG. 1 in order to illustrate a conventional configuration for separating illumination light and detection light in an optical apparatus. Subsequently, embodiments are described with reference to FIGS. 2 to 5 illustrating the differences of embodiments of the invention compared to the conventional configuration.

It is to be noted that FIGS. 1 to 5 serve only for illustrating those features which may help to understand an operating principle in the context of the present disclosure. Needless to say that the specific configurations shown in FIGS. 1 to 5 may comprise additional components. In particular, FIGS. 1 to 5 show microscopes as examples. It is evident that these microscopes would include additional elements as for example lenses, filters, light sources, etc. when put into practice.

FIG. 1 shows a conventional laser scanning microscope 100 as an example of an optical apparatus using a conventional beam splitting device 102 for separating illumination light applied to a sample and detection light emerging therefrom.

The beam splitting device 102 of the comparative example includes a light supply unit which is formed by two optical fibers 104 and 106. The first optical fiber 104 is used to supply first illumination light 108 through a lens 110 into an optical illumination path of the laser scanning microscope 100. Just as an example, it may be assumed that the first illumination light 108 includes wavelengths within a first wavelength range from about 440 nm to 800 nm. Hereinafter, a direction along which the first illumination light 108 propagates in the laser scanning microscope 100 is illustrated by dot-dash arrows. The second optical fiber 106 is used to supply second illumination light 112 through a lens 114 into the optical illumination path. In this example, it may be assumed that the second illumination light 112 includes wavelengths within a second wavelength range from about 400 nm to 410 nm. Hereinafter, a direction along which the second illumination light 112 propagates in the laser scanning microscope 100 is illustrated by double dot-dash arrows.

The beam splitting device 102 comprises an acousto-optical component 116 formed by a crystal provided with a piezoelectric transducer which can be electrically tuned to create sound waves in the crystal serving as a diffraction grating. For this comparative example, it is assumed that the acousto-optical component 116 and a driver electronics thereof are limited in terms of a spectral width to the first wavelength range from 440 nm to 800 nm. Thus, the acousto-optical component 116 is only configured to actively influence the first illumination light 108 by diffraction but not the second illumination light 112. Accordingly, the beam splitting device 102 is designed to supply only the first illumination light 108 via the acousto-optical component 116 into the illumination path whereas the second illumination light 112 bypasses the acousto-optical component when introduced into the illumination path. In other words, the beam splitting device 102 shown in FIG. 1 uses two spatially separated ports represented by the two optical fibers 104 and 106 for coupling the first illumination light 108 and the second illumination light 112 into the illumination path wherein the port represented by the optical fiber 106 bypasses the acousto-optical component.

Specifically, the first illumination light 108 emitted from the optical fiber 104 is reflected by a mirror 118 towards the acousto-optical component 116. The acousto-optical component 116 is configured to diffract a spectral component of the first illumination light 108 to generate an illumination light beam 120 of a first diffraction order emerging from the acousto-optical component 116 along an optical axis of the illumination path leading to the sample. A direction along which the first illumination light 108 reflected by the mirror 118 enters the acousto-optical component 116 is inclined such that the first diffraction order of the first illumination light 108 created by the acousto-optical element 116 is deflected to be coincident, i.e. collinear with the optical axis O of the illumination path. After passing through a dichroic mirror 122, the illumination light beam 120 formed from the first diffraction order of the illumination light 108 propagates along the optical axis O towards the sample.

The second illumination light 112 emitted from the optical fiber 106 is reflected by the dichroic mirror 122 along the optical axis O so that the second illumination light 112 is spatially combined with the first illumination light 108. As a result, the sample is illuminated with light which is composed of light components being formed by the first and second illumination lights 108, 112.

The beam splitting device 102 is further configured to guide detection light 124 from the sample to a detector 126 of the laser scanning microscope 100 in a direction opposite to the propagation direction of the first and second illumination lights 108, 112 illuminating the sample. Hereinafter, a direction along which the detection light 124 propagates in the laser scanning microscope 100 is illustrated by dashed arrows in FIG. 1. The detection light 124 enters the acousto-optical component 116 through the dichroic mirror 122 and remains unaffected by the acousto-optical component 116 in terms of diffraction when passing therethrough. Accordingly, the detection light 124 emerges from the acousto-optical component 116 without being diffracted thereby. After propagating past the mirror 118, the detection light 124 enters an additional acousto-optical component 128 which is provided to compensate for a prismatic effect which is caused by the acousto-optical component 116. For this purpose, the additional acousto-optical component 128 is structurally identical with the acousto-optical component 116 and opposedly oriented thereto. Thus, the additional acousto-optical component 128 forms a passive element in terms of diffraction so that the detection light 124 passes through the acousto-optical component 128 towards the detector 126 without being diffracted.

It is to be noted that the acousto-optical component 116 is illustrated in FIG. 1 in a very simplified way. In particular, the acousto-optical component 116 has usually not the shape of a parallelepiped as shown in FIG. 1 where light input and output surfaces of the acousto-optical component 116 are illustrated as parallel surfaces. Rather, the acousto-optical component 116 may be provided with light entrance and exit surfaces which are tilted relative to each other.

In the comparative example shown in FIG. 1, it must be considered as a drawback that the first illumination light 108 and the second illumination light 112 are supplied to the illumination path by means of two spatially separated ports represented by the optical fibers 104, 106. Thus, the spatially separated light coupling into the illumination path requires the first and second illumination lights 108, 112 to be guided through different optical components which may cause a drift or misalignment e.g. due to thermal expansion. Further, a lateral shift of the focus of the illumination light originating from one optical fiber relative to the focus of the illumination light originating from the other optical fiber may occur. This may result in instabilities between the illumination foci and color-dependent offsets of the foci. In addition, providing two separate ports for coupling the illumination light into the system requires separate optical components, mountings and adjustment elements as optical fibers, lenses, mirrors etc. up to the point in the illumination path where the illumination light is combined. Thus, the costs for implementing such a configuration are high.

In the following, embodiments are described which are suitable to overcome the afore-mentioned drawbacks.

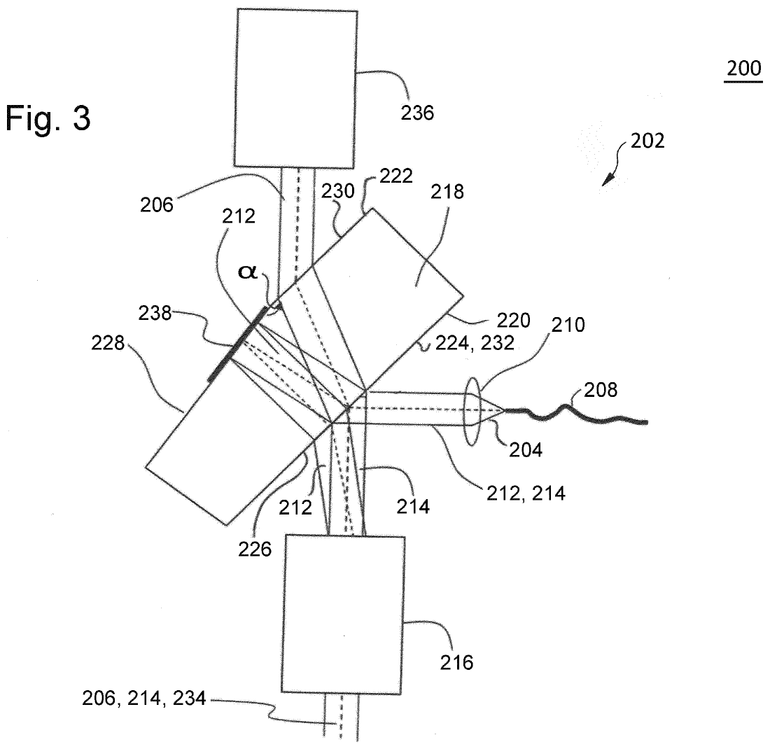

FIGS. 2 and 3 show a laser scanning microscope 200 comprising a beam splitting device 202 which is used for separating illumination light 204 applied to a sample and detection light 206 emerging therefrom. FIGS. 2 and 3 show the same configuration and differ only in how the light propagation is illustrated. Whereas FIG. 3 illustrates the light in form of light bundles, FIG. 2 shows only a chief or central ray of the respective light bundle (corresponding to FIG. 1). The beam splitting device 202 of the laser scanning microscope 200 includes a light supply unit 208 which may be formed by a single optical fiber. The light supply unit 208 is configured to supply the illumination light 204 through a lens 210 into an optical illumination path of the laser scanning microscope. Taking up the comparative example of FIG. 1, it may be assumed that the illumination light 204 includes first illumination light 212 having wavelengths within a first wavelength range from about 440 nm to 800 nm and second illumination light 214 having wavelengths within a second wavelength range from about 400 nm to 410 nm. Accordingly, the first and second wavelength ranges are spectrally separated from each other. Needless to say, that the afore-mentioned wavelength ranges are to be understood merely as examples. Further, the spectral separation of the wavelength ranges is not limited to a case where the ranges are separated from each other by a spectral gap which is from 410 nm to 440 nm in the present example. Rather, the spectral separation of the wavelength ranges is to be understood to cover a case where the first and second wavelength ranges adjoin each other without any gap so that the entire illumination light 204 including the first and second illumination lights 212, 214 exhibit a continuous spectrum which may be provided e.g. which may be emitted by a white light laser into the optical fiber 208. As in FIG. 1, directions along which the first and second illumination lights 212, 214 propagate in the laser scanning microscope 200 are illustrated by dot-dash arrows and double dot-dash arrows, respectively. Likewise, the light propagation direction of the detection light 206 is illustrated by dashed arrows.

The beam splitting device 202 comprises an acousto-optical component 216 which essentially corresponds to the acousto-optical component 116 of the comparative example shown in FIG. 1. Thus, the acousto-optical component 216 may be formed by a crystal provided with a piezoelectric transducer which can be electrically tuned to create sound waves in the crystal which serve as a diffraction grating for the light transmitting the crystal. As in the comparative example, it is assumed that the acousto-optical component 216 and the driver electronics thereof are limited in terms of a spectral width to the first wavelength range from 440 nm to 800 nm. Accordingly, the acousto-optical component 216 is only configured to actively influence wavelengths from 440 nm to 800 nm by diffraction. Wavelengths outside this range are not intended to be diffracted by the acousto-optical component 216.

The acousto-optical component 216 is illustrated in a very simplified way likewise. Thus, the acousto-optical component 116 has usually not the shape of a parallelepiped as shown in FIG. 2 where light input and output surfaces of the acousto-optical component 216 are illustrated as parallel surfaces. Rather, the acousto-optical component 216 may be provided with light entrance and exit surfaces which are tilted relative to each other.

The beam splitting device 202 comprises a light coupling unit 218 which is configured to couple the first illumination light 212 and the second illumination light 214 from the single optical fiber 208 into the acousto-optical component 216. Thus, the light coupling unit 218 enables the entire illumination light 204 to be supplied to the illumination path via one single port which is represented by the optical fiber 208. In particular, the optical fiber 208 can be used to emit the first illumination light 212 and the second illumination light 214 in a collinear manner towards the light coupling unit 218. Then, as explained below in more detail, the light coupling unit 218 separates the first illumination light 212 and the second illumination light 214 spatially from each other and directs the first illumination light 212 and the second illumination light 214 along different light propagation directions into the acousto-optical component 216. Accordingly, in contrast to the comparative example of FIG. 1 where the acousto-optical component 116 is bypassed by the second illumination light 112, the embodiment shown in FIG. 2 enables not only the first illumination light 212 but also the second illumination light 214 to be transmitted through the acousto-optical component 216.

The light coupling unit 218 may comprise an optical element which is configured to reflect the first and second illumination lights 212, 214 along different propagation directions into the acousto-optical component 216. According to the embodiment shown in FIG. 2, the optical element may be a prism with a front surface 220 facing a light output end of the optical fiber 208 and a back surface 222 facing away from the optical fiber 208. The front surface 220 comprises a first front surface portion 224 and a second front surface portion 226 spatially separated from the first front surface portion 224. Likewise, the back surface 222 comprises a first back surface portion 228 and a second back surface portion 230 which is spatially separated from the first back surface portion 228.

According to the embodiment shown in FIG. 2, the front surface 220 of the light coupling unit 218 is formed by a single planar surface. Accordingly, the first and second front surface portions 224, 226 are coplanar. In contrast, the first and second back surface portions are not coplanar, i.e. tilted by an angle α relative to each other. Further, the first back surface portion 228 is oriented such that it is non-parallel to the planar front surface 228. In contrast, the second back surface portion 230 is oriented to be parallel to the planar front surface 220.

The first front surface portion 224 may be provided with a dichroic layer 232 having a spectral characteristic which is adapted to the wavelengths of the light propagating in the laser scanning microscope 200. Specifically, the dichroic layer 232 is configured to transmit the first illumination light 212 and the detection light 206 and to reflect the second illumination light 214. Thus, the first illumination light 212 is refracted by the dichroic layer 232 when entering the light coupling unit 218 towards the first back surface portion 228.

The front surface 220 of the light coupling unit 218 is oriented such that the second illumination light 214 is reflected towards the acousto-optical component 216. According to the configuration shown in FIGS. 2 and 3, a surface normal of the front surface 220 is oblique with respect to the incident direction of the first and second illumination lights 212, 214 at the light coupling unit 218. Accordingly, the surface normal of the front surface 220 is also oblique with respect to a direction along which the second illumination light 214 is reflected at the front surface 220 towards the acousto-optical component 216. Further, the first back surface portion 228 is configured to reflect the first illumination light 212 which is refracted by the dichroic layer 232 back to the front surface 220 where it is deflected by refraction to emerge from the light coupling unit 218 towards the acousto-optical component 216 along a propagation which differs from the propagation direction of the second illumination light 214 entering the acousto-optical component 216. Specifically, the propagation directions of the first and second illumination lights 212, 214 towards the acousto-optical component 216 are tilted to each other by an angle which corresponds to the angle α by which the first and second back surface portions 228, 230 are tilted to each other. In order to reflect the first illumination light 212 back towards the front surface 220, the first back surface portion 228 may be provided with a reflective coating 238, e.g. a metallic coating or a dielectric coating.

The acousto-optical component 216 may be tunable by a suitable driver electronics to diffract at least one spectral component of the first illumination light 212 having a selected wavelength to generate at least one illumination light beam 234 of a predetermined diffraction order while transmitting the second illumination light 214 without diffraction. According to the embodiment shown in FIGS. 2 and 3, the acousto-optical component 216 is configured to provide for a diffraction of the first illumination light 212 in a first diffraction order. Further, the light coupling unit 218 and the acousto-optical component 216 are adapted to each other in terms of the light propagation directions along which the first and second illumination lights 212, 214 are deflected by the light coupling unit 218 towards the acousto-optical component 216 such that the at least one illumination light beam 234 of the first illumination light 212 and the second illumination light 214 transmitted without diffraction emerge collinearly or at least in parallel from the acousto-optical component 216. Accordingly, the first and second illumination lights 212, 214 are combined by the acousto-optical component 216 in a manner which secures an illumination of the sample with spatially coinciding light in a broad wavelength region which is composed of the first and second illumination lights 212, 214.

The acousto-optical component 216 is further configured to guide the detection light 206 from the sample in a direction opposite to the propagation direction of the first and second illumination lights 212, 214. Again, a direction along which the detection light 214 propagates in the laser scanning microscope 200 is illustrated by dashed arrows in FIG. 2. The detection light 206 remains unaffected by the acousto-optical component 216 when passing therethrough. Thus, the detection light 206 emerges from the acousto-optical component 216 without being diffracted thereby. The detection light 206 transmits the light coupling unit 218 while being laterally shifted due to refraction at the front surface 220 and the second back surface portion 230 which is parallel thereto. After passing the light coupling unit 218, the detection light 206 enters the additional acousto-optical component 236 which is provided to compensate for a prismatic effect which is caused by the acousto-optical component 216. Similar to the comparative example shown in FIG. 1, the additional acousto-optical component 220 is structurally identical with the acousto-optical component 216 and oppositely oriented thereto. Accordingly, the acousto-optical component 236 forms a passive element in terms of diffraction so that the detection light 206 propagates towards a detector without being diffracted.

The beam splitting device 202 may comprise optical means which are configured to alter a polarization state of at least one of the first and second illumination lights 212, 214 such that the illumination light beam 234, i.e. the first diffraction order generated by the acousto-optical component 216 from the first illumination light, and the second illumination light 214 emerge from the acousto-optical component 216 with equal polarization states. The afore-mentioned optical means securing equal polarization states may e.g. comprise the reflective coating 238 which is applied onto the first back surface portion 228 of the light coupling unit 218 to reflect the first illumination light 212 back to the front surface 220. The reflective coating 238 might be implemented in such a way that it does not cause a phase shift when reflecting the first illumination light 212. This might be realized, for example, by having the reflective coating 238 contain or consist of alternating, dielectric thin layers with different refractive indices (for example alternating between a low and a high refractive index), wherein one of the layers is in contact with a glass body of the light coupling unit 218 and exhibits a refractive index lower than the refractive index of the glass body of the light coupling unit 218. During reflection at this interface the light wave does not exhibit a phase shift. For such a type of reflective coating 238, maximum reflectance of the illumination light 212 at a single wavelength might be achieved with each layer having a thickness of a quarter of the wavelength of the illumination light 212.

The above described implementations of the reflective coating 238 are only examples. Other suitable implementations of reflective coatings 238 reflecting the illumination light without phase shift might for example be provided with multiple layers with different refractive index, wherein the layers might have a thickness differing from a quarter of the wavelength.

Taking into account such a characteristic of the reflective coating 238, linear polarized light may be used as illumination light 204 emitted from the optical fiber 208, wherein a polarization direction of the illumination light 204 is selected to be rotated by an angle of 45° relative to the plane of incidence of the illumination light 204 on the front surface 220 of the light coupling unit 218. Accordingly, the polarization direction of the second illumination light 214 reflected at the front surface 220 is rotated by an angle of 90°. As a result, the first and second illumination lights 212, 214 emerging from the light coupling unit 218 have polarization directions rotated relative to each other by 90°. Subsequently, the polarization direction of the first illumination light 212 is rotated by 90° by means of the acousto-optical component 216 when being diffracted into the first diffraction order. As a result, the illumination light beam 234 derived from the first illumination light 212 and the second illumination light 214 emerge from the acousto-optical component 216 with equal polarization states.

Needless to say that controlling the polarization of light in a manner as described above is to be understood merely as an example. For instance, rather than using the reflective coating 238 causing no phase shift, the polarization direction of the first illumination light may be rotated by 90° relative to the polarization direction of the second illumination light 214 before coupling the first illumination light 214 into the optical fiber 208. Such a rotation of the polarization direction may be effected by a waveplate taking into account that a polarization maintaining optical fiber can usually transmit not only a specified polarization direction but also the polarization direction rotated by 90°.

A tolerance of the angle α which determines the difference between the propagation directions along which the first and second illumination lights propagate into the acousto-optical component 216 may be chosen such that a lateral deviation of the light foci in the sample is less than twice the half-width of the point spread function (PSF), preferably less than one half-width of the PSF, and even better less than half of the half-width of the PSF.

Further, it may be considered that the first illumination light 212 undergoes dispersion during its propagation between the front surface 220 and the first back surface portion 228 and after reflection between the first back surface portion 228 and the front surface 220, which results in a wavelength-dependent angular splitting of the first illumination light 212 emerging from the light coupling unit 218. Accordingly, a wavelength-dependent lateral offset of the illumination foci in the sample may occur. Further, the crystal of the acousto-optical component 216 generally also leads to a wavelength-dependent angular splitting due to its dispersion and thus also to a wavelength-dependent lateral offset of the illumination foci. Accordingly, the light coupling unit 218 and the acousto-optical component 216 may be adapted to each other to compensate for a dispersion otherwise resulting in a lateral offset of the illumination foci. In particular, by selecting a suitable material of the light coupling unit 218 it can be achieved that the angular splitting caused by the light coupling unit 218 is equal or at least nearly equal in magnitude to the angular splitting caused by the acousto-optical component 216.

Just as an example, assumed that the acousto-optical component 216 has an angular dispersion of 0.9 mrad between the wavelengths of 490 nm and 800 nm, for the first diffraction order the same angular dispersion can be achieved in a case where the light coupling unit 218 consists of the glass material N-PK51 from SCHOTT (Abbe number vd=76.98), the surface normal of the front surface 220 of the light coupling unit 218 exhibits an angle of 45° with respect to the incident direction of the first and second illumination lights 212, 214, and the first and second back surface portions 228, 230 are tilted to each other by an angle α of 2°.

In general, the acousto-optical components 216, 236 are preferably designed in such a way that the angular dispersions between the wavelengths of 490 nm and 800 nm for the first diffraction order are small, i.e. preferably less than 1.5 mrad, more preferably less than 1.0 mrad, and most preferably less than 0.8 mrad. The glass material of the light coupling unit 218 has preferably an Abbe number of more than 50, more preferably of more than 60, and most preferably of more than 70.

The light coupling unit 218 may be oriented in such a way that the direction of the angular dispersion of the light coupling unit 218 is opposite to the direction of the angular dispersion of the acousto-optical component 216. Thus, by suitably arranging the light coupling unit 218 with respect to the acousto-optical component 216 a compensation of a wavelength-dependent angular splitting can be achieved.

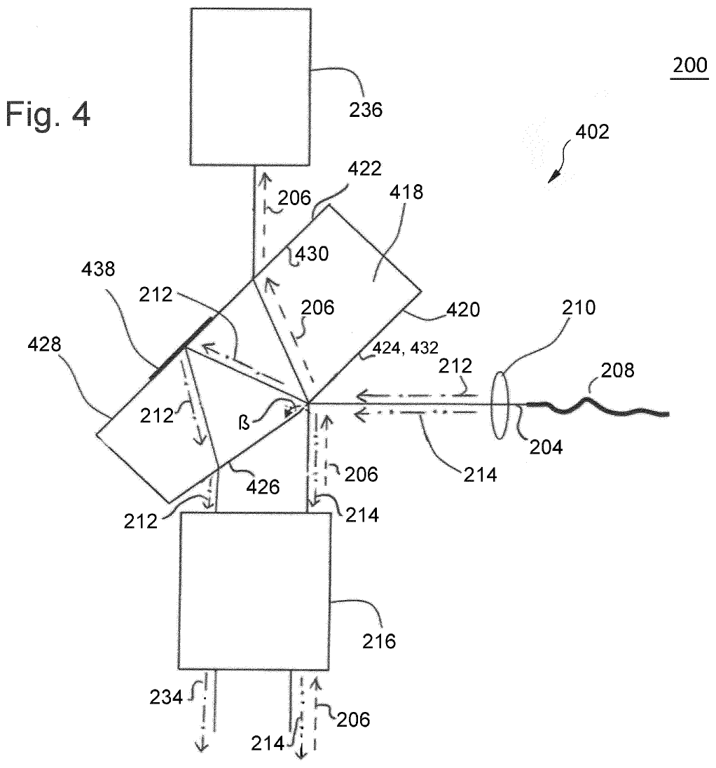

FIG. 4 shows a beam splitting device 402 according to another embodiment which may be included in the laser scanning microscope 200. The beam splitting device 402 of FIG. 4 essentially differs from the embodiment shown in FIGS. 2 and 3 by a modified light coupling unit 418.

The light coupling unit 418 shown in FIG. 4 comprises a front surface 420 with a first front surface portion 424 and a second front surface portion 426. In contrast to the embodiment shown in FIGS. 2 and 3, the first and second front surface portions 424, 426 are not coplanar. Rather, the first and second front surface portions 424, 426 are tilted by an angle relative to each other. Further, the light coupling unit 418 comprises a back surface 422 with a first back surface portion 428 and a second back surface portion 430. According to the embodiment shown in FIG. 4, the back surface 422 including the first and second back surface portions 428, 430 is formed by a single planar surface which is parallel to the first front surface portion 424 and non-parallel to the second front surface portion 426.

The first front surface portion 424 is provided with a dichroic layer 432 which transmits both the first illumination light 212 and the detection light 206 and reflects the second illumination light 214. Thus, the first illumination light 212 is refracted by the dichroic layer 432 when entering the light coupling unit 418 towards the first back surface portion 428.

The first front surface portion 424 of the light coupling unit 418 is oriented such that the second illumination light 214 is reflected towards the acousto-optical component 216. A surface normal of the front surface portion 424 is oblique with respect to the incident direction of the first and second illumination lights 212, 214 at the light coupling unit 218. Accordingly, the surface normal of the front surface 424 is also oblique with respect to a direction along which the second illumination light 214 is reflected at the front surface 424 towards the acousto-optical component 216.

The first back surface portion 428 of the light coupling unit 418 is configured to reflect the first illumination light 212 which is refracted by the dichroic layer 432 back to the second front surface portion 426 which is tilted by the angle β relative to the first front surface portion 424. When passing through the second front surface portion 426, the first illumination light 212 is deflected by refraction to emerge from the light coupling unit 418 towards the acousto-optical component 216 along a propagation direction which differs from the propagation direction of the second illumination light 214 entering the acousto-optical component 216. Similar to the embodiment shown in FIGS. 2 and 3, the propagation directions of the first and second illumination lights 212, 214 towards the acousto-optical component 216 deviate from each other in accordance with the angle β by which the first and second front surface portions 424, 426 are tilted to each other. In order to reflect the first illumination light 212 back towards the second front surface portion 426, the first back surface portion 428 may be provided with a reflective coating 438, e.g. a metallic coating or a dielectric coating.

As in the embodiment shown in FIGS. 2 and 3, the acousto-optical component 216 of the beam splitting device 402 is tunable to diffract at least one spectral component of the first illumination light 212 in order to generate the at least one illumination light beam 234 while transmitting the second illumination light 214 without diffraction. The light coupling unit 418 and the acousto-optical component 216 are adapted to each other such that the at least one illumination light beam 234 of the first illumination light 212 and the second illumination light 214 emerge collinearly or at least (as illustrated in FIG. 4) in parallel from the acousto-optical component 216 to illuminate the sample.

Similar to the embodiment shown in FIGS. 2 and 3, the acousto-optical component 216 of the beam splitting device 402 is configured to guide the detection light 206 from the sample in a direction opposite to the propagation direction of the first and second illumination lights 212, 214. The detection light 206 remains unaffected in terms of diffraction by the acousto-optical component 216 when passing therethrough. Thus, the detection light 206 emerges from the acousto-optical component 216 without being diffracted. The detection light 206 transmits the light coupling unit 418 while being laterally shifted due to refraction at the first front surface portion 424 and the second back surface portion 430. Since the first front surface portion 424 and the second back surface portion 430 are parallel to each other, only a parallel displacement of the detection light 206 is caused by the light coupling unit 418. After passing the additional acousto-optical component 236 which serves to compensate the prismatic effect, the detection light 206 falls onto the detector.

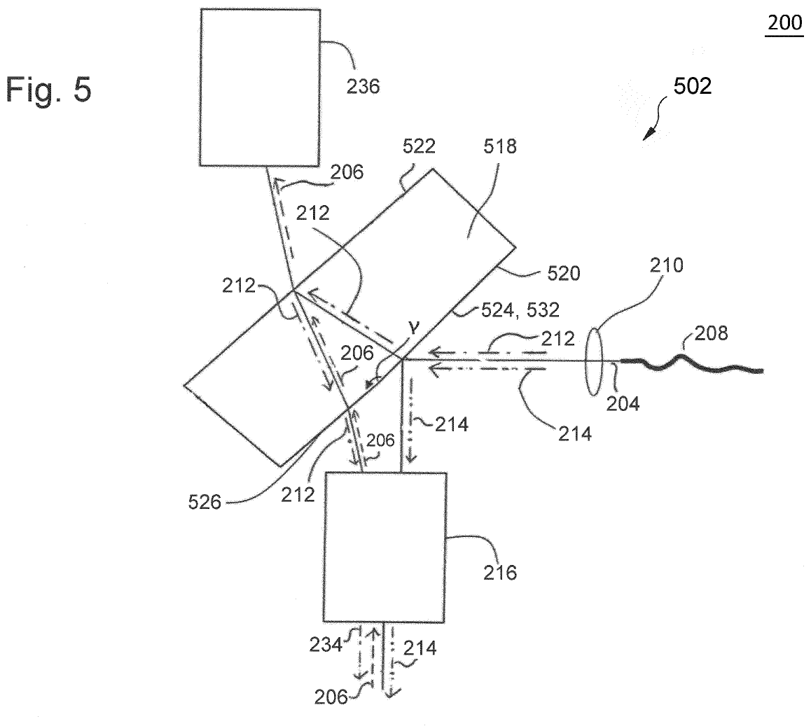

FIG. 5 shows a beam splitting device 502 according to another embodiment which may be included in the laser scanning microscope 200. The configuration shown in FIG. 5 differs from the embodiments of FIGS. 2 to 4 essentially by a modified light coupling unit 518 used in the beam splitting device 502.

The light coupling unit 518 has a front surface 520 with a first front surface portion 524 and a second front surface portion 526. The first and second front surface portions 524, 526 are not coplanar, i.e. tilted by an angle γ relative to each other. Further, the light coupling unit 518 shown in FIG. 5 comprises a back surface 522 which is formed by a single planar surface being parallel to the second front surface portion 526 and non-parallel to the first front surface portion 524.

The first front surface portion 524 of the light coupling unit 518 is provided with a dichroic layer 532 which transmits the first illumination light 212 and reflects the second illumination light 214. The back surface 522 of the light coupling unit 518 may be provided with a reflective coating which is adapted to reflect the first illumination light 212 transmitted by the dichroic layer 532 back to the second front surface portion 526. Further, the reflective coating applied to the back surface 522 is adapted to transmit the detection light 206.

As in the embodiments shown in FIGS. 2 to 4, the acousto-optical component 216 of the beam splitting device 502 is tunable to diffract at least one spectral component of the first illumination light 212 in order to generate the at least one illumination light beam 234 while transmitting the second illumination light 214 without diffraction. The light coupling unit 518 and the acousto-optical component 216 are adapted to each other such that the at least one illumination light beam 234 of the first illumination light 212 and the second illumination light 214 emerge collinearly from the acousto-optical component 216 to illuminate the sample.

As in the embodiments described above, the acousto-optical component 216 of the beam splitting device 518 is configured to guide the detection light 206 from the sample through the light coupling unit 518 to the detector. The detection light 206 remains unaffected by diffraction when passing through the acousto-optical component 216. However, the detection light 206 may be deflected by refraction by means of the acousto-optical component 216 as illustrated in FIG. 5. The detection light 206 may pass through the light coupling unit 518 along a direction which is opposite to the propagation direction in which the first illumination light 212 is reflected at the back surface 522 towards the second front surface portion 526 of the light coupling unit 518. Thus, the detection light 206 and the first illumination light 212 fall onto the same position on the back surface 522 where the afore-mentioned reflective coating is applied which reflects the first illumination light 212 and transmits the detection light 206. After passing the additional acousto-optical component 236 which serves to compensate the prismatic effect, the detection light 206 falls onto the detector. As already mentioned above, the detection light 206 may pass through several additional components as for example lenses, mirrors, filters, pinholes etc. before arriving at the detector.

In order to secure that the illumination light beam 234, i.e. the first diffraction order generated by the acousto-optical component 216 from the first illumination light, and the second illumination light 214 emerge from the acousto-optical component 216 with equal polarization states, the polarization direction of the first illumination light may be rotated by 90° relative to the polarization direction of the second illumination light 214 before coupling the first illumination light 214 into the optical fiber 208. As already mentioned above, such a rotation of the polarization direction may be effected by a waveplate.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 laser scanning microscope
102 beam splitting device
104 optical fiber
106 optical fiber
108 illumination light
112 illumination light
116 acousto-optical component
118 mirror
120 illumination light beam
122 dichroic mirror
124 detection light
126 detector
128 additional acousto-optical component
200 laser scanning microscope
202 beam splitting device
204 illumination light
206 detection light
208 light supply unit
210 lens
212 illumination light
214 illumination light
216 acousto-optical component
218 light coupling unit
220 front surface
222 back surface
224 front surface portion
226 front surface portion
228 back surface portion
230 back surface portion
232 dichroic layer
234 illumination light beam
238 reflective coating
402 beam splitting device
418 light coupling unit
420 front surface
424 front surface portion
426 front surface portion
428 back surface portion
430 back surface portion
432 dichroic layer
438 reflective coating
502 beam splitting device
518 light coupling unit
520 front surface
522 back surface
524 front surface portion
526 front surface portion
532 dichroic layer
O optical axis
α angle
β angle
γ angle

1. A beam splitting device for separating illumination light and detection light in an optical apparatus, the beam splitting device comprising:
a light supply configured to supply the illumination light including first illumination light having wavelengths within a first wavelength range and second illumination light having wavelengths within a second wavelength range, the first and second wavelength ranges being separated from each other,
an acousto-optical component tunable to diffract at least one spectral component of the first illumination light having a selected wavelength within the first wavelength range to generate at least one illumination light beam of a predetermined diffraction order while transmitting the second illumination light within the second wavelength range without diffraction, and
a light coupler configured to couple the first illumination light and the second illumination light from the light supply into the acousto-optical component,
wherein the light supply is configured to supply the first illumination light and the second illumination light collinearly to the light coupler, and
wherein the light coupler is configured to spatially separate the first illumination light and the second illumination light for directing the spatially separated first and second illumination lights along different light propagation directions into the acousto-optical component.

2. The beam splitting device according to claim 1, wherein the light supply comprises a single optical fiber which is configured to emit the first illumination light and the second illumination light collinearly towards to the light coupler.

3. The beam splitting device according to claim 1, wherein the acousto-optical component is configured to transmit the detection light without diffraction.

4. The beam splitting device according to claim 1, wherein the light coupler comprises an optical element which is configured to reflect the first and second illumination lights along the different propagation directions into the acousto-optical component.

5. The beam splitting device according to claim 1, wherein the light coupler comprises a front surface facing towards the light supply and a back surface facing away from the supply,
wherein the front surface comprises a first front surface portion with a dichroic layer configured to reflect one of the first and second lights towards the acousto-optical component and to transmit the other of the first and second lights by refraction towards the back surface,
wherein the back surface comprises a first back surface portion configured to reflect the other of the first and second lights back to the front surface,
wherein the front surface comprises a second front surface portion spatially separated from the first front surface portion and configured to transmit the other of the first and second lights reflected back from the first back surface portion by refraction towards the acousto-optical component, and
wherein the first back surface portion is non-parallel to at least one of the first and second front surface portions.

6. The beam splitting device according to claim 5, wherein the first back surface portion, comprises a reflective coating configured to reflect the other of the first and second lights back to the second front surface portion.

7. The beam splitting device according to claim 5, wherein the front surface including the first and second front surface portions is formed by a single planar surface, and
wherein the first back surface portion is non-parallel to the planar front surface.

8. The beam splitting device according to claim 5, wherein the back surface including the first back surface portion is formed by a single planar surface, and
wherein one of the first and second front surface portions is non-parallel to the planar back surface while the other of the first and second front surface portions is parallel to the planar back surface.

9. The beam splitting device according to claim 5, wherein the back surface comprises a second back surface portion which is parallel to one of the first and second front surface portions.

10. The beam splitting device according to claim 5, wherein the optical element is configured to transmit the detection light through surface portions of the front and back surfaces which are parallel to each other.

11. The beam splitting device according to claim 1, wherein the light coupler and the acousto-optical component are adapted to each other such that the at least one diffracted illumination light beam of the first illumination light and the second illumination light transmitted without diffraction emerge from the acousto-optical component collinearly or at least in parallel.

12. The beam splitting device, according to claim 1, comprising optics configured to alter a polarization state of at least one of the first and second illumination lights such that the at least one diffracted illumination beam of the first illumination light and the second illumination light emerge from the acousto-optical component with equal polarization states.

13. The beam splitting device according to claim 1, wherein the light coupler and the acousto-optical component are adapted to each other to compensate for dispersion.

14. The beam splitting device according to claim 1, comprising a further acousto-optical component for transmitting the detection light-W towards a detector, wherein the additional acousto-optical component is configured to compensate for a prismatic effect caused by the acousto-optical component.

15. An optical apparatus comprising the beam splitting device according to claim 1.

16. The optical apparatus of claim 15, wherein the optical apparatus is a microscope.

17. The optical apparatus of claim 16, wherein the optical apparatus is a laser scanning microscope.
